(19) United States
(12) Patent Application Publication
(10) Pub. No.: US 2026/0103945 A1
(43) Pub. Date: Apr. 16, 2026

(54) WIRE BUNDLER, THROUGH-AXLE SPRING STRUCTURE, AND SUN SHADING APPARATUS

(71) Applicant: Dongguan Lingxin Intelligent Technology Co., Ltd., Dongguan City (CN)

(72) Inventors: Xiaohong LOU, Dongguan City (CN); Meifeng SHENG, Dongguan City (CN); Erfang LOU, Dongguan City (CN); Huibi TUO, Dongguan City (CN)

(21) Appl. No.: 19/023,621

(22) Filed: Jan. 16, 2025

(30) Foreign Application Priority Data
Oct. 16, 2024 (CN) 202422498131.9
Jan. 7, 2025 (CN) 202510025871.7
Jan. 7, 2025 (CN) 202520035577.X

(51) Int. Cl. E06B 9/322

(52) U.S. Cl. CPC E06B 9/322

(57) ABSTRACT

The present invention provides a wire bundler, a through-axle spring structure, and a sun shading apparatus. The wire bundler includes an engaging gear and an engaging block. A first engaging tooth and a second engaging tooth protrude from an upper side of an engaging block body, and one of the first engaging tooth and the second engaging tooth can selectively engage with the engaging gear, such that the engaging gear and the wire bundling wheel are limited to be capable of rotating only in one direction. The wire bundler is simple in structure, allowing for more convenient retraction or release operation of a lifting rope.

### CROSS-REFERENCE TO RELATED APPLICATIONS

This application claims priority to Chinese Patent Application 202510025871.7, filed on January 7, 2025, Chinese Patent Application 202520035577.X, filed on January 7, 2025, and Chinese Patent Application 202422498131.9, filed on October 16, 2024, which are incorporated herein by reference.

### TECHNICAL FIELD

The present invention relates to the technical field of sun shading apparatuses, specifically to a wire bundler, a through-axle spring structure, and a sun shading apparatus including such wire bundler and through-axle spring structure.

### BACKGROUND

With the development and progress of society, curtain products are continuously updated, and continuously emerging innovative designs therefor have made them widely popular as decorative materials for doors and windows. Currently, most curtains sold in the market have a lower end of a curtain body connected with a pull rope, and the pull rope is retracted or released to lift or lower the curtain body. Additionally, the length of the pull rope can be adjusted using a wire bundler, thereby adjusting the position of the lower end of the curtain body, allowing the lower end of the curtain body to achieve a desired position or angle. However, the existing wire bundler has a complex structure and is inconvenient to process. Additionally, it is operated in complicated steps; usually, the length of the pull rope can be adjusted using the wire bundler only after the curtain body is retracted, resulting in inconvenient operations for the user.

Additionally, the existing curtain has a built-in spring mechanism in a tube body, and the force of a coil-wound spring is used as a core power source to drive the curtain body to be lifted and lowered. The common curtain design often relies on a single fixed spring box structure, and such structure shows certain limitations in adjusting the spring force, with a narrow adjustable range. Therefore, in a case of curtains with different materials and weights, the adaptability of such design appears inadequate, making it difficult to achieve precise matching and flexible adjustment.

### SUMMARY

To address at least one of the above problems, the present invention provides a wire bundler, a through-axle spring structure, and a sun shading apparatus.

The present invention is implemented through the following solutions:

The present invention provides a wire bundler, where the wire bundler is configured to connect a lifting rope of a sun shading apparatus to a lower end of a curtain body of the sun shading apparatus, and the wire bundler includes:

a wire bundling plate; a wire bundling wheel, where the wire bundling wheel is pivotally connected to the wire bundling plate, the wire bundling wheel includes a wheel-shaped body, an end of the wheel-shaped body is provided with a pivot shaft, the wheel-shaped body is positioned on a side of the wire bundling plate, the wheel-shaped body is positioned on an inner side of the wire bundling plate, and the pivot shaft passes through the wire bundling plate and protrudes to an outer side of the wire bundling plate; an engaging gear, where the engaging gear is mounted on the pivot shaft, relative rotation between the engaging gear and the wire bundling wheel is limited, and the engaging gear is positioned on the outer side of the wire bundling plate, and an engaging block, where the engaging block is pivotally connected to the outer side of the wire bundling plate, the engaging block is located below the engaging gear, the engaging block includes an engaging block body, and a first engaging tooth and a second engaging tooth protrude from an upper side of the engaging block body; and the engaging block pivots relative to the wire bundling plate, allowing one of the first engaging tooth and the second engaging tooth to selectively engage with the engaging gear, such that the engaging gear and the wire bundling wheel are limited to be capable of rotating only in one direction.

In an embodiment, when the first engaging tooth engages with the engaging gear, the engaging gear and the wire bundling wheel are capable of rotating only in a first direction; and when the second engaging tooth engages with the engaging gear, the engaging gear and the wire bundling wheel are capable of rotating only in a second direction, the first direction being opposite to the second direction for rotation.

In an embodiment, the engaging block pivots around a central axis relative to the wire bundling plate, and the first engaging tooth and the second engaging tooth are distributed on two sides of the central axis.

In an embodiment, the wire bundler further includes a pushing member and an elastic member, a lower side of the engaging block body is provided with a pushed protrusion, the pushed protrusion has a first side surface and a second side surface that are inclined relative to each other, the pushing member is provided below the engaging block, and the elastic member abuts against the pushing member and pushes the pushing member towards the engaging block; the pushing member is capable of selectively abutting against the first side surface or the second side surface of the engaging block; when the pushing member abuts against the first side surface of the engaging block, a state of the second engaging tooth engaging with the engaging gear is able to be maintained; and when the pushing member abuts against the second side surface of the engaging block, a state of the first engaging tooth engaging with the engaging gear is able to be maintained.

In an embodiment, the wire bundling plate is provided with a mounting cavity, and the pushing member and the elastic member are movably provided in the mounting cavity; and the wire bundling plate includes a wire bundling plate body, an outer side of the wire bundling plate body is connected with a mounting block, the mounting cavity is formed in the mounting block, and a top surface of the mounting block is in an arc shape concave inward.

In an embodiment, the wire bundler further includes a rotating member, the rotating member is fixedly connected to an end of the pivot shaft, and the rotating member is mounted on an outer side of the engaging gear; and the rotating member is wheel-shaped, and an outer circumference of the rotating member is provided with anti-slip teeth.

In an embodiment, the wire bundling plate includes a wire bundling plate body, left and right sides of the wire bundling plate body are provided with a left widened portion and a right widened portion, and the wire bundling plate body has a left transition surface and a right transition surface, such that widths of the wire bundling plate body at the left transition surface and the right transition surface increase from top to bottom.

In an embodiment, an outer circumferential surface of the wheel-shaped body is provided with a winding groove along a circumferential direction, the winding groove is substantially located in the middle of the wheel-shaped body, and the wheel-shaped body is further provided with a wire fixing hole that penetrates a bottom surface of the winding groove.

In an embodiment, the wire bundling plate includes a wire bundling plate body in a shape of a flat plate, and a lower end of the wire bundling plate body is provided with a hook-shaped portion.

The present invention further provides a sun shading apparatus, at least including the wire bundler as described above.

In an embodiment, the sun shading apparatus further includes a through-axle spring structure, and the through-axle spring structure includes:

an upper rail assembly, including an upper rail, a wire retracting module mounted on a bottom surface of the upper rail, and a drive shaft rotatably connected to the wire retracting module; and

at least one spring box detachably connected to the bottom surface of the upper rail, where the spring box includes a housing, and a first connection structure and a second connection structure that are connected to the housing, where the first connection structure and the second connection structure are correspondingly arranged, and the first connection structure and the second connection structure are capable of being mounted and connected to each other, thus achieving fixed connection between two spring boxes.

The present invention further provides a through-axle spring structure, including an upper rail assembly, including an upper rail, a wire retracting module mounted on a bottom surface of the upper rail, and a drive shaft rotatably connected to the wire retracting module; and at least one spring box detachably connected to the bottom surface of the upper rail, where the spring box includes a housing, and a first connection structure and a second connection structure that are connected to the housing, where the first connection structure and the second connection structure are correspondingly arranged, and the first connection structure and the second connection structure are capable of being mounted and connected to each other, thus achieving fixed connection between two spring boxes.

In an embodiment, the through-axle spring structure further includes a bearing plate mounted at a bottom of the upper rail assembly, the bearing plate is mounted on the bottom surface of the upper rail, two T-shaped slots are arranged side by side in a surface of the bearing plate back away from the upper rail, and the two T-shaped slots are arranged in a length direction of the bearing plate.

The housing includes a box body and a cover plate in matchable connection with the box body; the spring box further includes first clamping legs that are connected to a top surface of the box body and located on two opposite sides, and second clamping legs that are connected to a top surface of the cover plate and located on two opposite sides; the first clamping leg is T-shaped, and the first clamping leg is in matchable connection with the T-shaped slot; and the second clamping leg is T-shaped, and the second clamping leg is in matchable connection with the T-shaped slot, such that the spring box is detachably connected to the bearing plate and thus is detachably connected to the bottom surface of the upper rail.

In an embodiment, two wire retracting modules are provided and mounted at two opposite ends of the bottom surface of the upper rail; the first connection structure is an alignment seat, the second connection structure is a lug, the spring box is provided with two lugs and two alignment seats, the two alignment seats are connected to two opposite sides of the box body, and the two lugs are connected to two opposite sides of the cover plate; when the two spring boxes are spliced in a same direction, the box body of one spring box abuts against the cover plate of the other spring box; and screws pass through the lugs and are threaded into the alignment seats, thereby achieving mutual mounting and connection between the alignment seats and the lugs.

In an embodiment, the spring box further includes a first balance wheel rotatably mounted at a top end in the box body, a second balance wheel rotatably mounted at a bottom end in the box body, and a spiral spring connecting the first balance wheel and the second balance wheel; and the drive shaft coaxially passes through the first balance wheel to drive the first balance wheel to rotate synchronously.

In an embodiment, a cross section of the drive shaft is non-circular; and the first balance wheel is provided with an axis hole in a direction of an axis line of the first balance wheel, and a hole shape of the axis hole matches a cross-sectional shape of the drive shaft.

In an embodiment, the spiral spring is S-shaped, one end of the spiral spring is fixedly connected to the first balance wheel, and the other end of the spiral spring is fixedly connected to the second balance wheel, such that the first balance wheel and the second balance wheel rotate in opposite directions.

In an embodiment, a middle part of the bottom surface of the upper rail is concaved inward along a length direction of the upper rail to form an accommodating groove; and along the length direction of the bearing plate, a boss protrudes from a middle part of a surface of the bearing plate facing the upper rail, and the boss correspondingly fits with the accommodating groove.

In an embodiment, multiple assembly holes are respectively provided on two opposite sides of the upper rail corresponding to the accommodating groove; and multiple pass-through grooves are respectively provided on two opposite sides of the bearing plate corresponding to the boss, the pass-through grooves being in one-to-one correspondence to the assembly holes.

In an embodiment, the drive shaft is a single shaft, and the single drive shaft passes through the wire retracting module and the spring box; and/or a mounting position of the wire retracting module on the bottom surface of the upper rail is adjustable.

The technical solutions provided by the present invention have the following technical effects:

The present invention provides a wire bundler, including an engaging gear and an engaging block. The engaging block includes an engaging block body, and a first engaging tooth and a second engaging tooth protrude from an upper side of the engaging block body; and the engaging block pivots relative to the wire bundling plate, allowing one of the first engaging tooth and the second engaging tooth to selectively engage with the engaging gear, such that the engaging gear and the wire bundling wheel are limited to be capable of rotating only in one direction. This wire bundler is simple in structure and convenient to manufacture, and the wire bundler is operated in simple steps, allowing for more convenient retraction and release of the lifting rope.

The present invention also provides a sun shading apparatus, including a through-axle spring structure. The through-axle spring structure includes at least one spring box detachably connected to a bottom surface of an upper rail. The spring box includes a housing, and a first connection structure and a second connection structure that are connected to the housing. The first connection structure and the second connection structure are correspondingly arranged, and the first connection structure and the second connection structure are capable of being mounted and connected to each other, thus achieving fixed connection between two spring boxes. The through-axle spring structure is simple and convenient to use, and multiple spring boxes can be spliced and mounted, allowing for effective selection of different ranges of spring force, so as to adapt to curtains of different materials and weights. In this way, it is convenient to splice multiple spring boxes, and the position of the lifting rope is also convenient to adjust, so as to adapt to curtains of different specifications.

### BRIEF DESCRIPTION OF DRAWINGS

FIG. 1 is a three-dimensional diagram of a sun shading apparatus according to an embodiment of the present invention.

FIG. 2 is a three-dimensional diagram of the sun shading apparatus in another direction according to this embodiment.

FIG. 3 is a three-dimensional diagram of a wire bundler according to this embodiment.

FIG. 4 is an exploded view of a wire bundler according to this embodiment.

FIG. 5 is a three-dimensional diagram of a wire bundling plate according to this embodiment.

FIG. 6 is a three-dimensional diagram of an engaging gear according to this embodiment.

FIG. 7 is a three-dimensional diagram of an engaging plate according to this embodiment.

FIG. 8 is a three-dimensional diagram of a wire bundling wheel according to this embodiment.

FIG. 9 is a three-dimensional diagram of the wire bundling wheel in another direction according to this embodiment.

FIG. 10 is a three-dimensional diagram of a rotating member according to this embodiment.

FIG. 11 is a three-dimensional diagram of a through-axle spring structure according to this embodiment of the present invention.

FIG. 12 is a three-dimensional diagram of the through-axle spring structure from another angle of view according to this embodiment.

FIG. 13 is a partial exploded view of the through-axle spring structure according to this embodiment.

FIG. 14 is an enlarged view of circle A shown in FIG. 13.

FIG. 15 is a three-dimensional diagram of two spring boxes spliced in a same direction in the through-axle spring structure according to this embodiment.

FIG. 16 is an exploded view of the spring box according to this embodiment.

### DESCRIPTION OF EMBODIMENTS

To further describe the embodiments, the present invention provides accompanying drawings. These drawings are part of the disclosure of the present invention and are primarily used to illustrate embodiments and can be used with reference to the relevant description in the specification to explain the operating principles of the embodiments. Referring to this content, ordinary skilled persons in this field should understand other possible implementations and the advantages of the present invention. The components in the figure are not drawn to scale, and similar component symbols are typically used to represent similar components.

The present invention is further described with reference to the accompanying drawings and specific implementations.

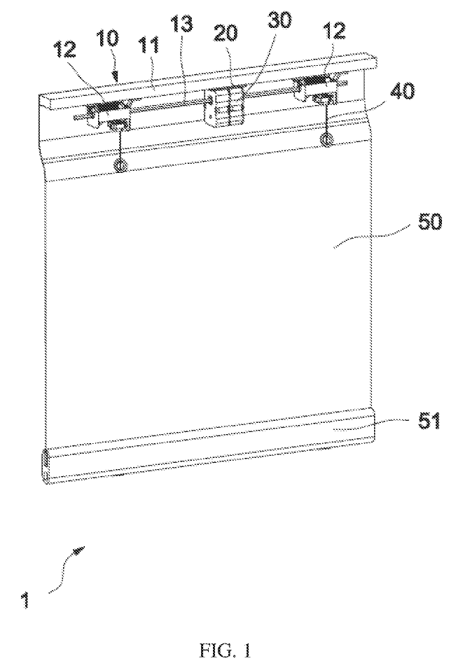

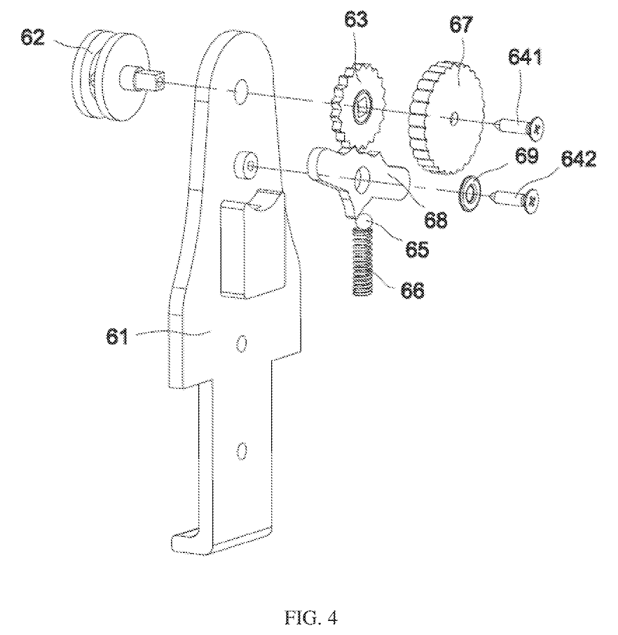

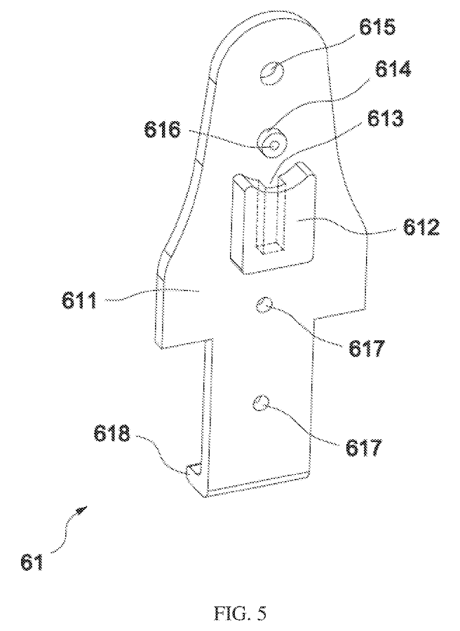

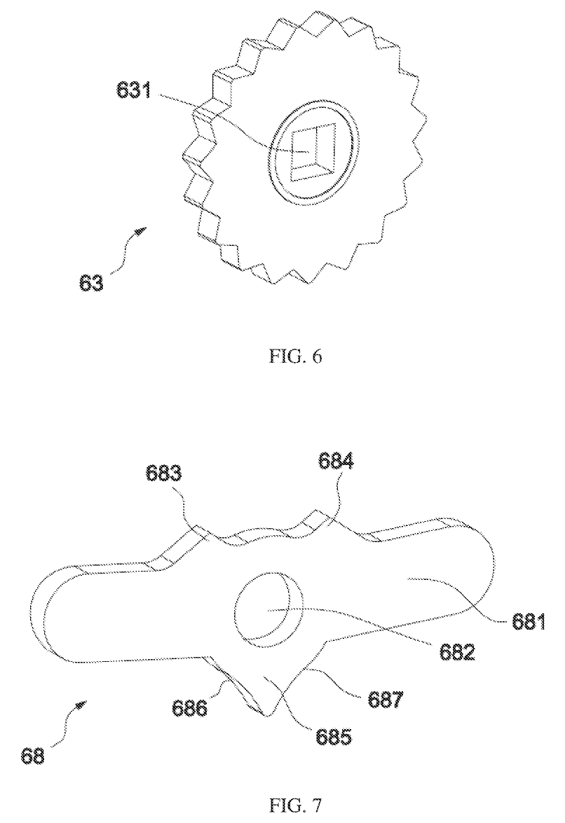

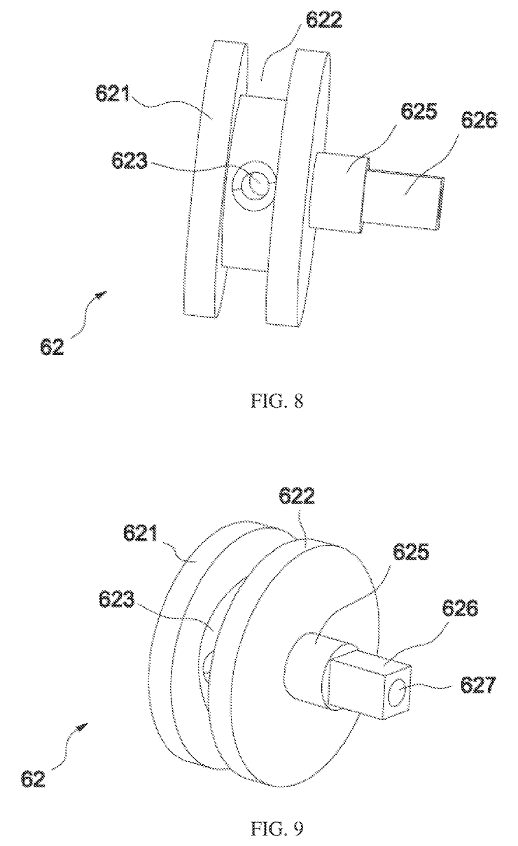

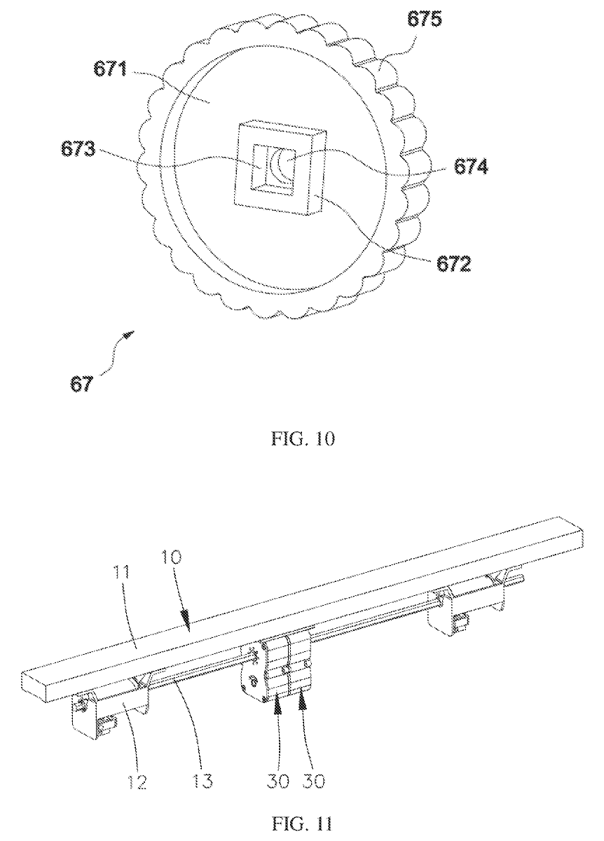

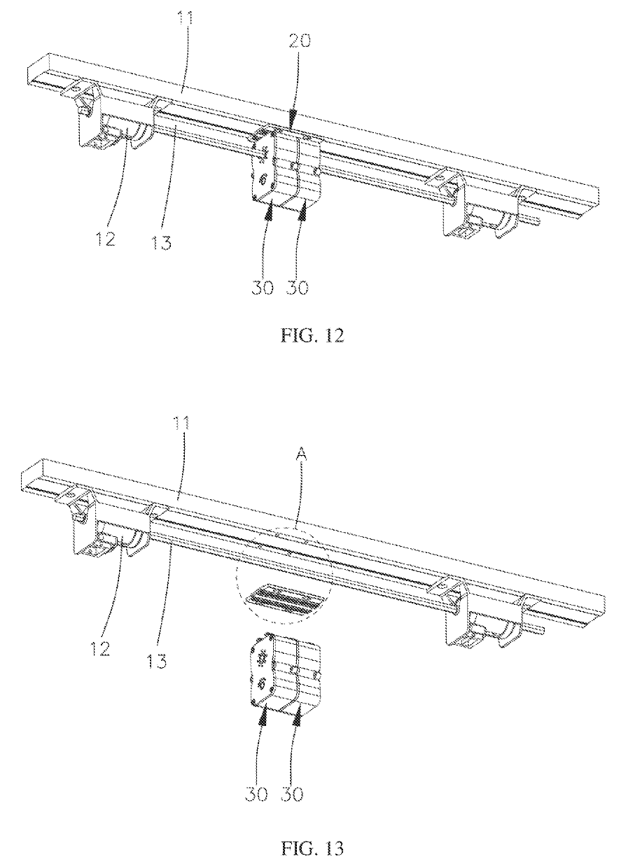

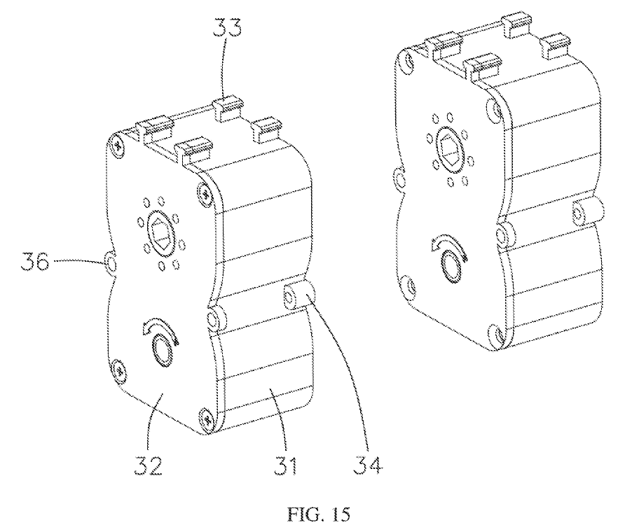

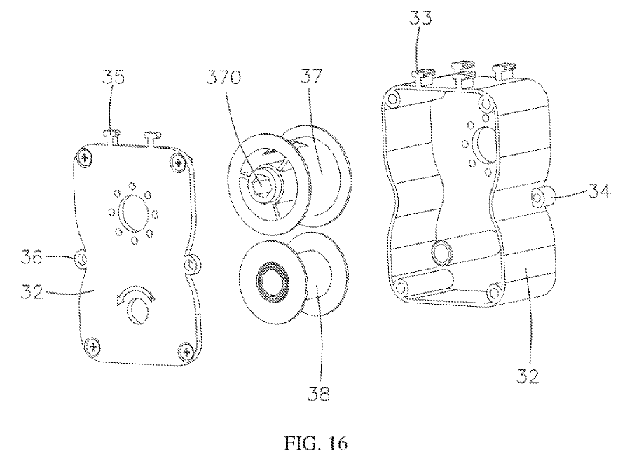

Referring to FIGS. 1 to 16, an embodiment provides a sun shading apparatus 1, and the sun shading apparatus 1 is, for example, a curtain. The sun shading apparatus 1 includes an upper rail assembly 10, a bearing plate 20, a spring box 30, a lifting rope 40, a curtain body 50, a wire bundler 60, and a positioning ring 70, where at least one spring box 30 is provided, and the bearing plate 20 is mounted at the bottom of the upper rail assembly 10. The upper rail assembly 10, the bearing plate 20, and the spring box 30 form a through-axle spring structure of the sun shading apparatus 1.

Referring to FIGS. 1 to 10, an upper rail assembly 10 includes an upper rail 11, a wire retracting module 12 mounted on a bottom surface of the upper rail 11, and a drive shaft 13 rotatably connected to the wire retracting module 12; and a cross section of the drive shaft 13 is non-circular. For example, in this embodiment, a cross section of the drive shaft 13 is hexagonal; and two wire retracting modules 12 are provided and mounted at two opposite ends of the bottom surface of the upper rail 11. The drive shaft 13 passes through the wire retracting module 12 and the spring box 30. The spring box 30 is provided with a spiral spring, and the spring box 30 can provide resistance for the descent of the curtain body 50 and power for the ascent of the curtain body 50.

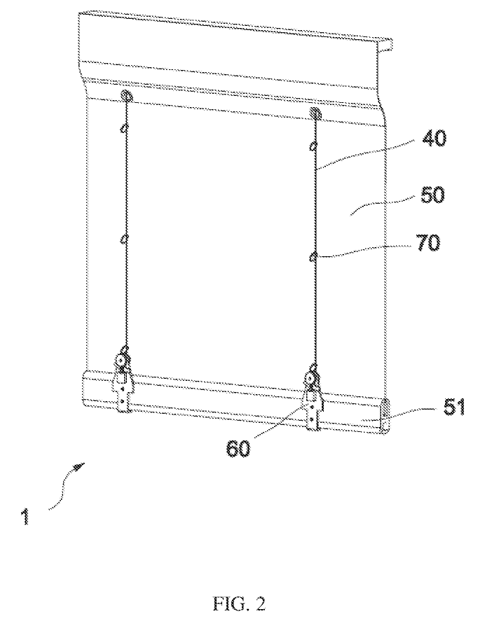

Referring to FIGS. 1 and 2, the lifting rope 40 can be gradually wound and retracted by the wire retracting module 12, thereby retracting the curtain body 50. The curtain body 50 includes a bottom rod 51 provided at the lower end, and the bottom rod 51 can increase the overall weight of the curtain body 50, making it easier for the curtain body 50 to stay at the desired height. A tail end of the lower portion of the lifting rope 40 is connected with a wire bundler 60, and the wire bundler 60 is fixedly connected to the bottom rod 51.

When the bottom rod 51 of the curtain body 50 in a retracted or partially retracted state is pulled down, the curtain body 50 unfolds from top to bottom, and the bottom of the curtain body 50 moves downward along with the bottom rod 51. The two lifting ropes 40 are released from the wire retracting module 12, causing the curtain body 50 to unfold.

A positioning ring 70 may be fixed on the surface of the curtain body 50, and the lifting rope 40 passes through the positioning ring 70. The positioning ring 70 can position and guide the lifting rope 40 relative to the curtain body 50. The mounting position of the wire retracting module 12 on the bottom surface of the upper rail 11 is adjustable, allowing for convenient adjustment of the position of the lifting rope 40, so as to adapt to curtains of different specifications.

Referring to FIGS. 1 to 10, the wire bundler 60 is configured to connect the lifting rope 40 of the sun shading apparatus 1 to the lower end of the curtain body 50 of the sun shading apparatus 1. The wire bundler 60 includes a wire bundling plate 61, a wire bundling wheel 62, an engaging gear 63, an engaging block 68, a pushing member 65, an elastic member 66, a rotating member 67, a gasket 69, a first screw 641, and a second screw 642.

The wire bundling plate 61 includes a wire bundling plate body 611 in a shape of a flat plate, and the wire bundling plate body 611 is provided with a mounting hole 617. The mounting hole 617 is used for screws to pass through, thereby fixedly connecting the wire bundling plate body 611 to the bottom rod 51. The lower end of the wire bundling plate body 611 is provided with a hook-shaped portion 618, and the hook-shaped portion 618 can hook onto the bottom of the bottom rod 51, thereby more securely connecting the wire bundler 60 to the bottom rod 51.

The wire bundling plate body 611 is also provided with a pivot hole 615. The wire bundling wheel 62 includes a wheel-shaped body 621, and an end of the wheel-shaped body 621 is provided with a pivot shaft 625. The pivot shaft 625 fits pivotally with the pivot hole 615, thereby pivotally connecting the wire bundling wheel 62 to the wire bundling plate 61, and the wheel-shaped body 621 is positioned on a side of the wire bundling plate 61. The wheel-shaped body 621 is defined to be positioned on an inner side of the wire bundling plate 61. The pivot shaft 625 passes through the wire bundling plate 61 and protrudes to the outer side of the wire bundling plate 61. The outer circumferential surface of the wheel-shaped body 621 is provided with a winding groove 622 along the circumferential direction, and the winding groove 622 is substantially located in the middle of the wheel-shaped body 621. The winding groove 622 may be used for winding the lifting rope 40. The wheel-shaped body 621 is further provided with a wire fixing hole 623 that penetrates the bottom surface of the winding groove 622. The wire fixing hole 623 may be used for fixing an end of the lifting rope 40, making it easier to wind the lifting rope 40 around the winding groove 622.

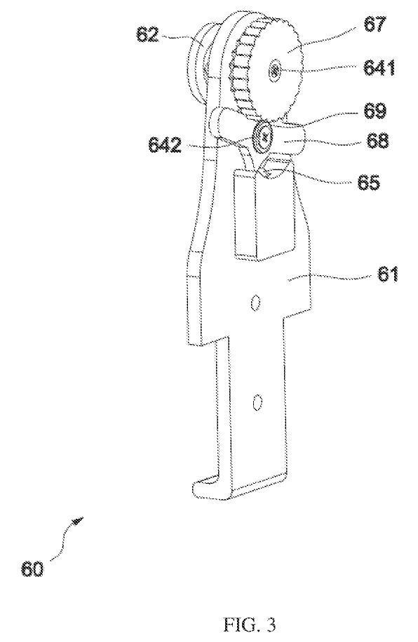

Referring to FIGS. 3 to 10, the engaging gear 63 is mounted on the pivot shaft 625, and relative rotation between the engaging gear 63 and the wire bundling wheel 62 is limited. Specifically, an end of the pivot shaft 625 away from the wheel-shaped body 621 is provided with a limiting portion 6251, and the cross section of the limiting portion 6251 is non-circular. For example, in this embodiment, the cross section of the limiting portion 6251 is quadrilateral. An engaging hole 631 is provided in the middle of the engaging gear 63, and the engaging hole 631 matches the shape of the limiting portion 6251. In this embodiment, the cross section of the engaging hole 631 is quadrilateral. The engaging hole 631 can fit with the limiting portion 6251, thereby limiting the relative rotation between the engaging gear 63 and the wire bundling wheel 62. When the wire bundling wheel 62 is assembled to the wire bundling plate 61, the limiting portion 6251 protrudes to the outer side of the wire bundling plate 61 away from the inner side of the wire bundling plate 61, and the engaging gear 63 is positioned on the outer side of the wire bundling plate 61.

The engaging block 68 is pivotally connected to the wire bundling plate 61, and the engaging block 68 is positioned on the outer side of the wire bundling plate 61. The outer side of the wire bundling plate body 611 is provided with a pivot boss 614. The middle of the engaging block 68 is provided with a pivot fitting hole 682, and the pivot fitting hole 682 can pivotally fit with the pivot boss 614, thereby pivotally connecting the engaging block 68 to the wire bundling plate 61. An end of the pivot boss 614 is provided with a second threaded hole 616. The second screw 642 can threadedly fit with the mounting hole 616 of the engaging block. The second screw 642 passes through the gasket 69, thereby positioning and mounting the engaging block 68 on the outer side of the wire bundling plate 61.

The engaging block 68 includes a plate-shaped engaging block body 681, and the length of the engaging block body 681 is significantly greater than the width, making the engaging block body 681 narrow and long. The engaging block 68 is located below the engaging gear 63, and a first engaging tooth 683 and a second engaging tooth 684 protrude from an upper side of the engaging block body 681. The engaging block 68 pivots around a central axis relative to the wire bundling plate 61, and the first engaging tooth 683 and the second engaging tooth 684 are distributed on two sides of the central axis. In this embodiment, the central axis is the central axis of the pivot boss 614. The pivoting of the engaging block 68 relative to the wire bundling plate 61 allows one of the first engaging tooth 683 and the second engaging tooth 684 to selectively engage with the engaging gear 63. When one of the first engaging tooth 683 and the second engaging tooth 684 engages with the engaging gear 63, the engaging block 68 limits the engaging gear 63 to be capable of rotating only in one direction, thereby limiting the wire bundling wheel 62 to be capable of rotating only in one direction. Specifically, when the first engaging tooth 683 engages with the engaging gear 63, the engaging gear 63 and the wire bundling wheel 62 can rotate only in the first direction; and when the second engaging tooth 684 engages with the engaging gear 63, the engaging gear 63 and the wire bundling wheel 62 can rotate only in the second direction, the first direction being opposite to the second direction for rotation.

The lower side of the engaging block body 681 back away from the upper side is provided with a pushed protrusion 685, and the pushed protrusion 685 has a first side surface 686 and a second side surface 687 that are inclined relative to each other. A pushing member 65 is provided below the engaging block 68. The elastic member 66 abuts against the pushing member 65 and pushes the pushing member 65 towards the engaging block 68. The pushing member 65 can selectively abut against the first side surface 686 or the second side surface 687 of the engaging block 68, and can maintain the state of one of the first engaging tooth 683 and the second engaging tooth 684 engaging with the engaging gear 63. Specifically, when the pushing member 65 abuts against the first side surface 686 of the engaging block 68, the second engaging tooth 684 engages with the engaging gear 63, and the state of the two engaging with each other can be maintained. When the pushing member 65 abuts against the second side surface 687 of the engaging block 68, the first engaging tooth 683 engages with the engaging gear 63, and the state of the two engaging with each other can be maintained.

Referring to FIGS. 3 to 10, the wire bundling plate 61 is provided with a mounting cavity 613, and the pushing member 65 and the elastic member 66 are movably provided in the mounting cavity 613. In this embodiment, the elastic member 66 is a spring. The outer side of the wire bundling plate body 611 is connected with a mounting block 612, and the mounting cavity 613 is formed in the mounting block 612. The top surface of the mounting block 612 is in an arc shape concave inward, thereby adaptively avoiding the movement trajectory of the lower end of the pushed protrusion 685, and better maintaining the pushing member 65 in the mounting cavity 613 without coming out.

The rotating member 67 is fixedly connected to an end of the pivot shaft 625, and the rotating member 67 is mounted on the outer side of the engaging gear 63. In this embodiment, the rotating member 67 is fixedly connected to an end of the limiting portion 6251. The inner side of the rotating member 67 is provided with an engaging fitting slot 673, and the engaging fitting slot 673 matches the shape of the limiting portion 6251 of the wire bundling wheel 62. In this embodiment, the cross section of the engaging fitting slot 673 is quadrilateral. The engaging fitting slot 673 is provided at an end of the limiting portion 6251, thereby limiting the relative rotation between the rotating member 67 and the wire bundling wheel 62. The end of the limiting portion 6251 is also provided with a first threaded hole 627, and the first threaded hole 627 can fit with the first screw 641 for mounting, thereby fixedly connecting the rotating member 67 to the end of the limiting portion 6251. In this embodiment, the inner side of the rotating member 67 is provided with an extending boss 672, and the engaging fitting slot 673 is formed in the extending boss 672. An outer through hole 674 runs through the rotating member 67 and is used for the penetration of the first threaded hole 627.

During use, the engaging block 68 is rotated manually, such that one of the first engaging tooth 683 and the second engaging tooth 684 engages with the engaging gear 63, adjusting the engaging gear 63 and the wire bundling wheel 62 to be capable of rotating only in the first direction or the second direction, thereby meeting the user's need to retract or release the wire. After the engaging block 68 is adjusted to a proper position, the rotating member 67 is manually rotated to drive the wire bundling wheel 62 to rotate, thereby retracting or releasing one end of the lifting rope 40. In this way, the position of the lower end of the curtain body 50 is adjusted, allowing the lower end of the curtain body 50 to be in the desired position or angle. The wire bundler 60 is simple in structure and is convenient to manufacture; and the wire bundler 60 is operated in simple steps, making it more convenient to retract or release the lifting rope 40.

In this embodiment, an end of the engaging block body 681 is rounded, thus providing a better tactile feel during manual rotation of the engaging block 68. The rotating member 67 is wheel-shaped, and the outer circumference of the rotating member 67 is provided with anti-slip teeth 675, thereby enhancing the friction during manual rotation of the rotating member 67.

Further, the left and right sides of the wire bundling plate body 611 are also provided with a left widened portion 6112 and a right widened portion 6113, and the wire bundling plate body 611 has a left transition surface 6114 and a right transition surface 6115, such that widths of the wire bundling plate body 611 at the left transition surface 6114 and the right transition surface 6115 increase from top to bottom. The left transition surface 6114 and the right transition surface 6115 may be planar or curved surfaces or a combination of planar and curved surfaces. During manual rotation of the engaging block 68, leverage can be applied through the left transition surface 6114 or the right transition surface 6115, making it easier to rotate the engaging block 68.

Referring to FIGS. 1 to 16, the spring box 30 includes a housing, a first connection structure 34, and a second connection structure 36 that are connected to the housing. In this embodiment, the housing includes a box body 31 and a cover plate 32 that is in matchable connection with the box body 31. The first connection structure 34 and the second connection structure 36 are correspondingly arranged, and the first connection structure 34 and the second connection structure 36 are capable of being mounted and connected to each other, thus achieving fixed connection between two spring boxes 30. In this embodiment, the first connection structure 34 is an alignment seat 34, and the second connection structure 36 is a lug 36. The alignment seat 34 and the lug 36 may be mounted and connected to each other. In some other embodiments, the first connection structure 34 and the second connection structure 36 may alternatively be two buckle structures matching each other.

In this embodiment, the spring box 30 is provided with two alignment seats 34 and two lugs 36. The two alignment seats 34 are connected to two opposite sides of a surface of the box body 31 away from the cover plate 32, and the two lugs 36 are connected to two opposite sides of the cover plate 32. The alignment seats 34 correspond to the lugs 36. When two spring boxes 30 are spliced in the same direction, the box body 31 of one spring box 30 abuts against the cover plate 32 of the other spring box 30. In addition, screws pass through the lugs 36 and are threaded into the alignment seats 34, thereby achieving mutual mounting and connection of the alignment seats 34 and the lugs 36, that is, achieving fixed connection of the two spring boxes 30.

The spring box 30 further includes a first balance wheel 37 rotatably mounted at a top end in the box body 31, a second balance wheel 38 rotatably mounted at a bottom end in the box body 31, and a spiral spring (not shown in the figure) connecting the first balance wheel 37 and the second balance wheel 38. The spiral spring is S-shaped, and one end of the spiral spring is fixedly connected to the first balance wheel 37 and the other end of the spiral spring is fixedly connected to the second balance wheel 38, such that the first balance wheel 37 and the second balance wheel 38 rotate in opposite directions.

The drive shaft 13 coaxially passes through the first balance wheel 37 to drive the first balance wheel 37 to rotate synchronously. Specifically, the first balance wheel 37 is provided with an axis hole 370 in a direction of an axis line thereof, and a hole shape of the axis hole 370 matches a cross-sectional shape of the drive shaft 13, such that the drive shaft 13 can drive the first balance wheel 37 to rotate synchronously.

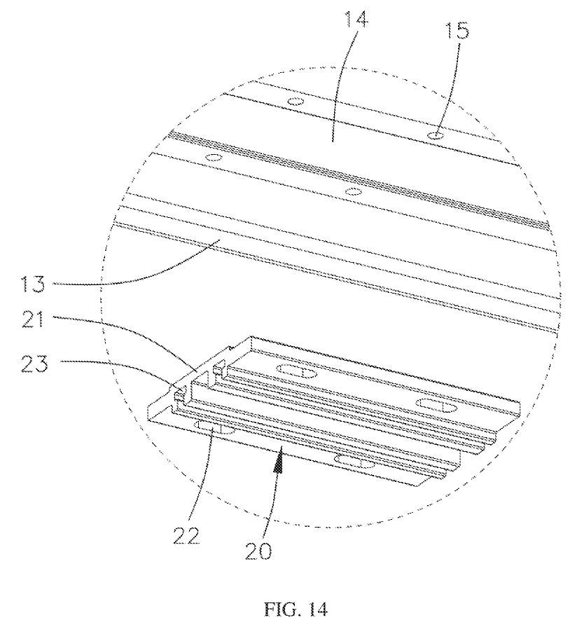

As shown in FIGS. 13 and 14, the spring box 30 is detachably connected to the bottom surface of the upper rail 11. The middle part of the bottom surface of the upper rail 11 is concaved inward along a length direction of the upper rail 11 to form an accommodating groove 14, multiple assembly holes 15 are respectively provided on two opposite sides of the upper rail 11 corresponding to the accommodating groove 14, and the accommodating groove 14 and the assembly hole 15 are used for positioning and connecting the bearing plate 20.

Along the length direction of the bearing plate 20, a boss 21 protrudes from the middle part of a surface of the bearing plate 20 facing the upper rail 11, and the boss 21 correspondingly fits with the accommodating groove 14. Multiple pass-through grooves 22 are respectively provided on two opposite sides of the bearing plate 20 corresponding to the boss 21, the pass-through grooves 22 being in one-to-one correspondence to the assembly holes 15. Bolts pass through the pass-through grooves 22 and are threaded into the assembly holes 15, fixedly mounting the bearing plate 20 on the bottom surface of the upper rail 11.

Two T-shaped slots 23 are arranged side by side in a surface of the bearing plate 20 back away from the upper rail 11, the two T-shaped slots 23 are arranged in a length direction of the bearing plate, and the T-shaped slots 23 are used for bearing and connecting the spring box 30.

In this embodiment, the spring box 30 further includes first clamping legs 33 that are connected to a top surface of the box body 31 and located on two opposite sides, and second clamping legs 35 that are connected to a top surface of the cover plate 32 and located on two opposite sides. The first clamping leg 33 is T-shaped, and the first clamping leg 33 is in matchable connection with the T-shaped slot 23, achieving detachable connection between the box body 31 and the bearing plate 20. The second clamping leg 35 is T-shaped, and the second clamping leg 35 is in matchable connection with the T-shaped slot 23, such that the cover plate 32 is detachably connected to the bearing plate 20, thus achieving detachable connection between the spring box 30 and the bottom surface of the upper rail 11. In actual use, different numbers of spring boxes 30 may be added to the bearing plate 20 as required, allowing for effective selection of different ranges of elastic force, so as to flexibly adapt to curtains of different materials and weights. Certainly, in some other embodiments, other detachable structures, such as buckle connectors, may be used between the spring box 30 and the bottom surface of the upper rail 11.

The above through-axle spring structure of this embodiment is simple and convenient to use. Multiple spring boxes 30 can be spliced and mounted on the bottom surface of the upper rail 11, allowing for effective selection of different ranges of elastic force, so as to flexibly adapt to curtains of different materials and weights. The drive shaft 13 is a single shaft, and the single drive shaft 13 passes through the wire retracting module 12 and the spring box 30. As compared with some other embodiments where a drive shaft 13 is formed by splicing multiple sections, in the solutions in this embodiment, a through-axle structure with a single drive shaft 13 is used, providing high load capacity, and it is more convenient to splice multiple spring boxes 30. Meanwhile, the position of the lifting rope 40 is also convenient to adjust, so as to adapt to curtains of different specifications.

Although the present invention is specifically illustrated and described with reference to preferred implementations, those skilled in the art should understand that without departing from the spirit and scope of the present invention as defined in the appended claims, various changes made to the present invention in form and details fall within the protection scope of the present invention.

1. A wire bundler, wherein the wire bundler is configured to connect a lifting rope of a sun shading apparatus to a lower end of a curtain body of the sun shading apparatus, and the wire bundler comprises:
a wire bundling plate;
a wire bundling wheel, wherein the wire bundling wheel is pivotally connected to the wire bundling plate, the wire bundling wheel comprises a wheel-shaped body, an end of the wheel-shaped body is provided with a pivot shaft, the wheel-shaped body is positioned on a side of the wire bundling plate, the wheel-shaped body is defined to be positioned on an inner side of the wire bundling plate, and the pivot shaft passes through the wire bundling plate and protrudes to an outer side of the wire bundling plate;
an engaging gear, wherein the engaging gear is mounted on the pivot shaft, relative rotation between the engaging gear and the wire bundling wheel is inhibited, and the engaging gear is positioned on the outer side of the wire bundling plate; and
an engaging block, wherein the engaging block is pivotally connected to the outer side of the wire bundling plate, the engaging block is located below the engaging gear, the engaging block comprises an engaging block body, a first engaging tooth and a second engaging tooth protrude from an upper side of the engaging block body, and the engaging block pivots relative to the wire bundling plate, allowing one of the first engaging tooth or the second engaging tooth to selectively engage with the engaging gear, such that the engaging gear and the wire bundling wheel are configured to rotate only in one direction.

2. The wire bundler according to claim 1, wherein when the first engaging tooth engages with the engaging gear, the engaging gear and the wire bundling wheel are configured to rotate only in a first direction, and when the second engaging tooth engages with the engaging gear, the engaging gear and the wire bundling wheel are configured to rotate rotating only in a second direction, the first direction being opposite to the second direction for rotation.

3. The wire bundler according to claim 1, wherein the engaging block pivots around a central axis relative to the wire bundling plate, and the first engaging tooth and the second engaging tooth are distributed on two sides of the central axis.

4. The wire bundler according to claim 1, wherein the wire bundler further comprises a pushing member and an elastic member, a lower side of the engaging block body is provided with a pushed protrusion, the pushed protrusion has a first side surface and a second side surface that are inclined relative to each other, the pushing member is provided below the engaging block, the elastic member abuts against the pushing member and pushes the pushing member towards the engaging block, the pushing member is configured to selectively abut against a first side surface or a second side surface of the engaging block, when the pushing member abuts against the first side surface of the engaging block, a state of the second engaging tooth engaging with the engaging gear is configured to be maintained, and when the pushing member abuts against the second side surface of the engaging block, a state of the first engaging tooth engaging with the engaging gear is configured to be maintained.

5. The wire bundler according to claim 4, wherein the wire bundling plate is provided with a mounting cavity, the pushing member and the elastic member are movably provided in the mounting cavity, the wire bundling plate comprises a wire bundling plate body, an outer side of the wire bundling plate body is connected with a mounting block, the mounting cavity is formed in the mounting block, and a top surface of the mounting block is in a concave surface.

6. The wire bundler according to claim 1, wherein the wire bundler further comprises a rotating member, the rotating member is fixedly connected to an end of the pivot shaft, the rotating member is mounted on an outer side of the engaging gear, the rotating member is wheel-shaped, and an outer circumference of the rotating member is provided with anti-slip teeth.

7. The wire bundler according to claim 1, wherein the wire bundling plate comprises a wire bundling plate body, a left side and a right side of the wire bundling plate body are provided with a left widened portion and a right widened portion, respectively, and the wire bundling plate body has a left transition surface and a right transition surface, such that widths of the wire bundling plate body at the left transition surface and the right transition surface increase from top to bottom.

8. The wire bundler according to claim 1, wherein an outer circumferential surface of the wheel-shaped body is provided with a winding groove along a circumferential direction, the winding groove is located in a middle of the wheel-shaped body, and the wheel-shaped body is further provided with a wire fixing hole that penetrates a bottom surface of the winding groove.

9. The wire bundler according to claim 1, wherein the wire bundling plate comprises a wire bundling plate body in a shape of a flat plate, and a lower end of the wire bundling plate body is provided with a hook-shaped portion.

10. A sun shading apparatus, at least comprising the wire bundler according to claim 1.

11. The sun shading apparatus according to claim 10, wherein the sun shading apparatus further comprises a through-axle spring structure, and the through-axle spring structure comprises:
an upper rail assembly, comprising an upper rail, a wire retracting module mounted on a bottom surface of the upper rail, and a drive shaft rotatably connected to the wire retracting module; and
at least one spring box detachably connected to the bottom surface of the upper rail, wherein the at least one spring box comprises a housing, and a first connection structure and a second connection structure that are connected to the housing, wherein the first connection structure and the second connection structure are correspondingly arranged, and the first connection structure and the second connection structure are configured to be mounted and connected to each other, thus achieving fixed connection between two spring boxes.

12. A through-axle spring structure, comprising:
an upper rail assembly, comprising an upper rail, a wire retracting module mounted on a bottom surface of the upper rail, and a drive shaft rotatably connected to the wire retracting module; and
at least one spring box detachably connected to the bottom surface of the upper rail, wherein the at least one spring box comprises a housing, and a first connection structure and a second connection structure that are connected to the housing, wherein the first connection structure and the second connection structure are correspondingly arranged, and the first connection structure and the second connection structure are configured to be mounted and connected to each other, thus achieving fixed connection between two spring boxes.

13. The through-axle spring structure according to claim 12, wherein the through-axle spring structure further comprises a bearing plate mounted at a bottom of the upper rail assembly, the bearing plate is mounted on the bottom surface of the upper rail, two T-shaped slots are arranged side by side in a surface of the bearing plate facing away from the upper rail, and the two T-shaped slots are arranged in a length direction of the bearing plate; and
the housing comprises a box body and a cover plate in matchable connection with the box body, the at least one spring box further comprises first clamping legs that are connected to a top surface of the box body and located on two opposite sides of the box body and second clamping legs that are connected to a top surface of the cover plate and located on two opposite sides of the cover plate, each of the first clamping legs is T-shaped, and each of the first clamping legs is in matchable connection with one of the two T-shaped slots, each of the second clamping legs is T-shaped, and each of the second clamping legs is in matchable connection with one of the two T-shaped slots, such that the at least one spring box is detachably connected to the bearing plate and thus is detachably connected to the bottom surface of the upper rail.

14. The through-axle spring structure according to claim 13, wherein two wire retracting modules are provided and mounted at two opposite ends of the bottom surface of the upper rail, the first connection structure is an alignment seat, the second connection structure is a lug, the at least one spring box is provided with two of the lugs and two of the alignment seats, the two alignment seats are connected to the two opposite sides of the box body, the two lugs are connected to the two opposite sides of the cover plate, when the two spring boxes are spliced in a same direction, the box body of one of the two spring boxes abuts against the cover plate of another of the two spring boxes, and screws pass through the two lugs and are threaded into the two alignment seats, thereby achieving mutual mounting and connection between the two alignment seats and the two lugs.

15. The through-axle spring structure according to claim 14, wherein the at least one spring box further comprises a first balance wheel rotatably mounted at a top end in the box body, a second balance wheel rotatably mounted at a bottom end in the box body, and a spiral spring connecting the first balance wheel and the second balance wheel, and the drive shaft coaxially passes through the first balance wheel to drive the first balance wheel to rotate synchronously.

16. The through-axle spring structure according to claim 15, wherein a cross section of the drive shaft is non-circular, the first balance wheel is provided with an axis hole in a direction of an axis line of the first balance wheel, and a hole shape of the axis hole matches a cross-sectional shape of the drive shaft.

17. The through-axle spring structure according to claim 15, wherein the spiral spring is S-shaped, one end of the spiral spring is fixedly connected to the first balance wheel, and a second end of the spiral spring is fixedly connected to the second balance wheel, such that the first balance wheel and the second balance wheel rotate in opposite directions.

18. The through-axle spring structure according to claim 14, wherein a middle part of the bottom surface of the upper rail is concaved along a length direction of the upper rail to form an accommodating groove, along the length direction of the bearing plate, a boss protrudes from a middle part of a second surface of the bearing plate facing the upper rail, and the boss correspondingly fits with the accommodating groove.

19. The through-axle spring structure according to claim 18, wherein multiple assembly holes are respectively provided on two opposite sides of the upper rail corresponding to the accommodating groove, multiple pass-through grooves are respectively provided on two opposite sides of the bearing plate corresponding to the boss, and the multiple pass-through grooves being in one-to-one correspondence to the multiple assembly holes.

20. The through-axle spring structure according to claim 12, wherein at least one of:
the drive shaft is a single drive shaft, and the single drive shaft passes through the wire retracting module and the at least one spring box; or
a mounting position of the wire retracting module on the bottom surface of the upper rail is adjustable.
